(19) United States
(12) Patent Application Publication
(10) Pub. No.: US 2025/0316418 A1
(43) Pub. Date: Oct. 9, 2025

(54) PLANAR TRANSFORMER WITH IMPROVED RELIABILITY

(71) Applicant: STMicroelectronics International N.V., Geneva (CH)

(72) Inventors: Francesco GUZZI, Cotronei (IT); Dario PACI, Vittuone (IT); Marco SALINA, Cremosano (IT); Nadia GALIMBERTI, Busnago (IT); Donata ASNAGHI, Agrate Brianza (IT); Riccardo GIANOLA, Bergamo (IT); Giuseppe VISALLI, Gorgonzola (IT); Marco DOSI, Levate (IT); Rossella CHIARA, Borgarello (IT)

(73) Assignee: STMicroelectronics International N.V., Geneva (CH)

(21) Appl. No.: 19/087,866

(22) Filed: Mar. 24, 2025

(30) Foreign Application Priority Data
Apr. 3, 2024 (IT) 102024000007306

(51) Int. Cl. H01F 38/14; H01F 27/28; H01F 27/32

(52) U.S. Cl. CPC H01F 38/14; H01F 27/2804; H01F 27/32

(57) ABSTRACT

Galvanic insulation device includes an upper coil in a first insulating layer; a lower coil in a second insulating layer; a galvanic insulation region extending between the first and the second insulating layers; and a first conductive via. Each of the upper coil and the lower coil includes turns, a first electrical contact region and a second electrical contact region, electrically coupled to the turns. The first conductive via is coupled to a first structural portion of the lower coil (2b), coupled to the turns or to the first or second electrical contact region. The first structural portion includes a first stress dissipation region having a curved shape and misaligned to the upper coil.

### BACKGROUND

### Technical Field

The present disclosure relates to a planar transformer with improved reliability. In detail, it relates to a galvanic insulation device and to an electronic device including the galvanic insulation device.

### Description of the Related Art

Transformers are widely used in a wide range of application fields, such as galvanic insulation, signal transfer and energy transfer. For example, in the field of galvanic insulation, integrated transformers are key components in many modern electronic products that require data exchange and/or energy transfer between two insulated electrical domains, such as medical devices, motor controllers and communication devices.

Commercially available systems typically use a plurality of coupling methods, which include inductive coupling for example based on planar transformers (i.e., having coils lying on respective planes parallel to each other). The reasons for these choices are many and include, for example, protection against voltages and currents.

In planar transformers, the coils are of conductive material, in particular metal material such as gold, and are vertically spaced from each other, and electrically decoupled from each other, by one or more layers of dielectric material, in particular polymeric material such as polyimide (PIX).

Generally, coils and layers of dielectric material have Coefficients of Thermal Expansion (CTE) that are significantly different from each other. Accordingly, the production of these transformers is critical since manufacturing steps that include thermal cycling (i.e., repeated significant temperature variations) may damage these devices.

In fact, the high CTE difference causes, during the production of the transformer (e.g., during the hardening/thermal annealing steps), high concentrations of mechanical stress at the interface between the coils and the dielectric material. This may lead to breakdowns of the dielectric layers, delaminations, detachments of the metal regions at the conductive vias, and more generally to the breakdown or malfunction of the transformer.

A similar risk exists during the operation of the device, in particular in the case of transformers for energy transfer/management (for example integrated transformers) which may be subject to self-heating during use.

Known solutions to this problem involve the use of materials with lower CTE differences. However, this complicates the design of transformers, introducing greater design constraints, and generally reduces their electrical performances.

Other known solutions involve the manufacturing of transformers through techniques that limit the number and extent of thermal cycling. However, this complicates the production of transformers and generally worsens their final structure and therefore their electrical performances.

Furthermore, galvanic insulation devices need to withstand the high difference in voltages both for short periods (for example during breakdown voltage tests) and for long periods, i.e., over the expected lifetime. However, when the previously mentioned polymeric materials are used as insulating and/or passivating layers, it is difficult to obtain an optimal thickness uniformity within the die. This implies that, in practice, between the upper and lower coils, the thickness of the polyimide usually has a significant variation along the horizontal plane (in detail, the thickness is greater in the central portion of the transformer than in the extremal portions, causing a “dome” shape of the transformer considered in cross-section).

The non-planarity of the insulating polymer layers between the two coils entails that the upper coil also follows a “dome-shaped” profile, in cross-section. This implies that in the outermost zones of the transformer, the upper coil is at a distance from the lower coil which is reduced with respect to the distance present between the two coils at the center of the transformer. The reduction of the distance between the coils at the respective external turns generates an unwanted increase in the electric field between the coils, which facilitates the formation of electric discharges between the coils at their external turns, determining the failure of the device. This thickness non-uniformity is for example caused by the manufacturing process of the transformer, in particular by the pyramidal multi-coating step.

A uniform thickness of insulating polymeric material is therefore required to allow voltage insulation both with respect to short voltage pulses and during the life of the transformer. In fact, in galvanic insulation devices that include PIX, the non-uniformity of the thickness of the PIX layers may lead to premature breakdown phenomena, reduced electrical performances and a shorter life of the device.

### BRIEF SUMMARY

The present disclosure is directed to provide a galvanic insulation device and an electronic device including the galvanic insulation device, which overcome the drawbacks of the prior art.

According to the present disclosure, a galvanic insulation device and an electronic device including the galvanic insulation device are provided.

### BRIEF DESCRIPTION OF THE SEVERAL VIEWS OF THE DRAWINGS

For a better understanding of the present disclosure, some embodiments are now described, purely by way of non-limiting example, with reference to the attached drawings, wherein:

FIG. 1 shows a circuit which includes a galvanic insulation device, in particular a transformer;

FIG. 2 illustrates, in a lateral sectional view, which is purely qualitative, a portion of the galvanic insulation device of FIG. 1, according to an embodiment of the present disclosure;

FIG. 3 shows, in a top view, a primary coil of the galvanic insulation device of FIG. 2, according to an embodiment of the present disclosure; and

FIGS. 4-7 show, in a top view, a secondary coil of the galvanic insulation device of FIG. 2, according to respective embodiments of the present disclosure.

In particular, the Figures are shown with reference to a triaxial Cartesian system defined by an X axis, a Y axis and a Z axis, orthogonal to each other.

In the following description, elements common to the different embodiments have been indicated with the same reference numbers.

### DETAILED DESCRIPTION

The present disclosure finds use in galvanic insulation devices (in particular, planar transformers) implemented in a PCB substrate that includes a plurality of stacked dielectric layers, as well as in galvanic insulation devices (in particular, planar transformers) made by using MEMS manufacturing techniques based on the processing of semiconductor substrates. The present disclosure may also be applied to planar transformers integrated into semiconductor structures (wafers, chips or dies) that accommodate a plurality of electronic devices.

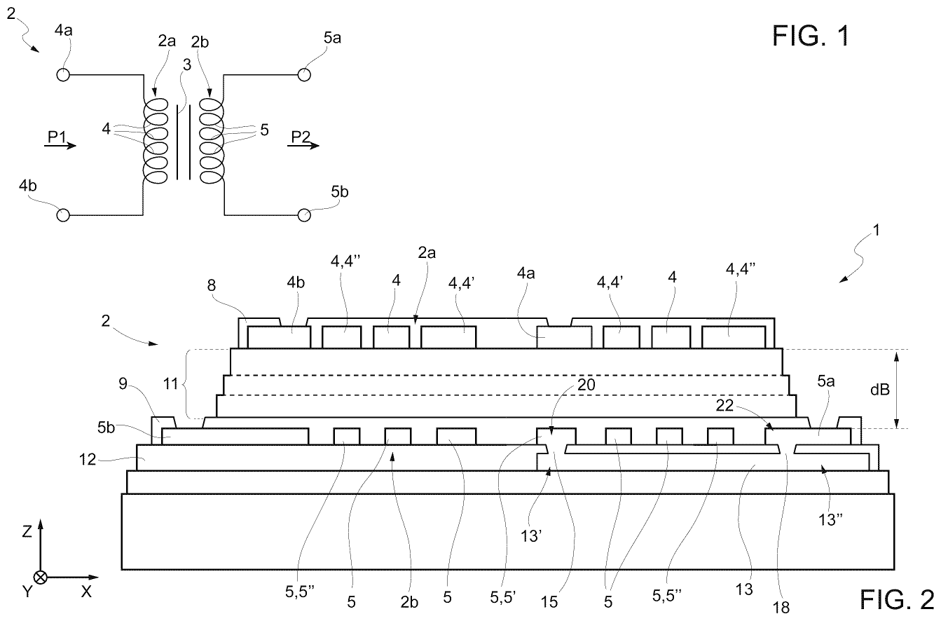

The equivalent circuit of FIG. 1 shows a galvanic insulation device (in particular, a transformer) 2 that may be used for the power transmission and/or conversion from an input port (to which an input power P1 is applied) to an output port (from which an output power P2 is generated). Therefore, in use, it is possible to transfer electric power through the transformer 2, or use the transformer 2 for the translation of a signal between two different voltage levels.

During use, the input power P1 is supplied to a primary coil 2a; a secondary coil 2b is coupled to the primary coil 2a and generates an output power P2, according to a transformation ratio, in a per se known manner.

Hereinafter, the terms “coil” and “winding” are used synonymously and interchangeably. The term “turn” identifies a single coil turn or coil loop of a spiral coil.

The primary and secondary coils 2a, 2b are electrically insulated from each other but are magnetically connected to allow for the transfer of electric power or electrical signal from one coil to another (and as a result for the transfer of electrical current induced through the concatenated magnetic flux between the two coils). A common core 3 may be present for this purpose.

When an electrical current flows through the turns of the primary coil 2a, a magnetic field develops which induces an electrical voltage in the turns of the secondary coil 2b. In use, the primary coil 2a of the transformer 2 is coupled to an input supply voltage generator (not shown) and converts (or transforms) the electric power P1 provided by the generator into a magnetic field; the secondary coil 2b converts this magnetic field into electric power P2 producing an output voltage. This possible application of the transformer 2 is illustrated for illustrative purposes only and does not limit the present disclosure.

With reference to FIG. 2, a portion of an electronic device, or electronic component 1, is illustrated in lateral-sectional view and in a triaxial reference system X, Y, Z.

The electronic device 1 includes the galvanic insulation device 2. In particular, the galvanic insulation device 2 may be a transformer and hereinafter is therefore also referred to as transformer 2.

The transformer 2 is of the planar type (i.e., it has the coils 2a and 2b lying on respective planes parallel to each other and parallel to the XY plane, also referred to as lying plane).

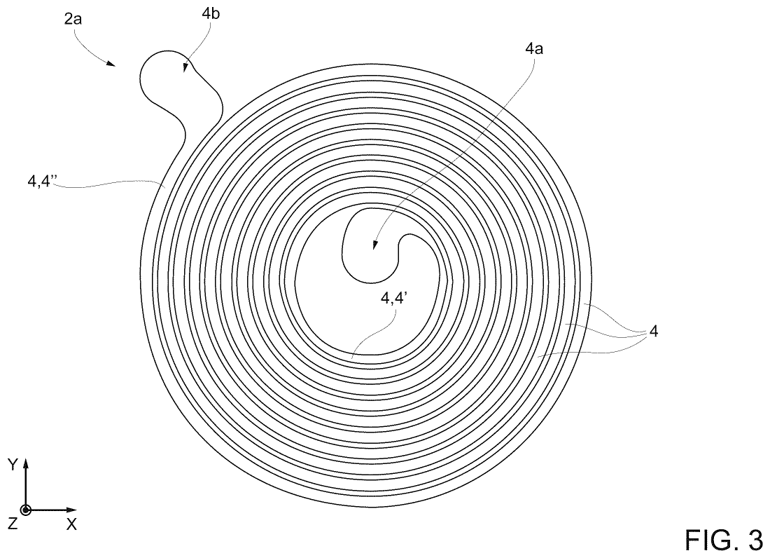

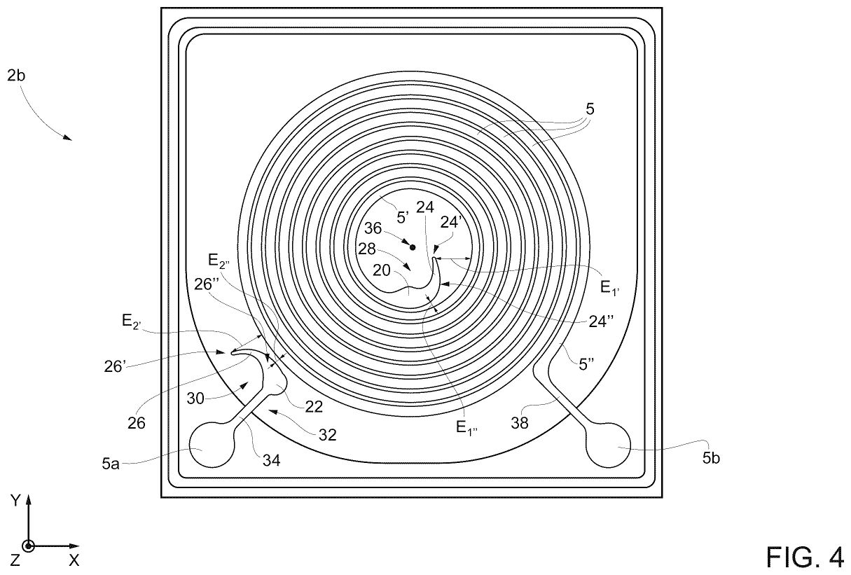

FIG. 2 is purely qualitative and illustrates various elements of the transformer 2, not necessarily visible along a same section line as FIGS. 3 and 4.

Considering the transformer 2 along the extension of the Z axis (orthogonal to the XY plane), the transformer 2 includes an upper coil (in this example, the primary coil 2a) and a lower coil (in this example, the secondary coil 2b) extending respectively into a first and a second insulating layer 8, 9 of electrically insulating or dielectric material (in detail, polymeric material such as PIX).

The coils 2a and 2b are vertically aligned with each other, i.e., aligned along the Z axis.

The coils 2a and 2b are each formed by a respective plurality of turns 4, 5. It is apparent that the number of turns is selected based on the needs of the application in which the transformer 2 is used or for which it is designed, and chosen in the design step in a per se known manner, for example, in a number equal to or greater than two, for example comprised between two and thirty.

The primary coil 2a and the secondary coil 2b extend to a distance dB from each other along the Z axis, separated from each other by one or more insulating layers of electrically insulating or dielectric material (in detail, polymeric material such as PIX) which forms a galvanic insulation region 11. The thickness of this galvanic insulation region 11, along the Z axis, may be a few tens of micrometers, for example comprised between 20 and 60 μm, for example 40 μm.

The primary coil 2a and the secondary coil 2b include the respective turns 4, 5 which extend parallel to the XY plane, according to a spiral path.

A first upper electrical contact region 4a, of metal material (for example, copper or gold), extends coplanar (i.e., in the same metal level) to the primary coil 2a within the turns 4 of the primary coil 2a. The first upper electrical contact region 4a is electrically coupled to the turns 4 of the primary coil 2a. More particularly, the first upper electrical contact region 4a is electrically coupled to the innermost turn 4′ of the primary coil 2a.

Similarly, a second upper electrical contact region 4b, of metal material (for example, copper or gold), extends coplanar to the primary coil 2a outside the turns of the primary coil 2a; the second upper electrical contact region 4b is electrically coupled to the turns of the primary winding 2a, in particular to the outermost turn 4″.

The first and the second upper electrical contact regions (or pads) 4a, 4b are configured to be electrically contacted in order to bias the respective primary coil 2a with a primary biasing voltage, as discussed with reference to FIG. 1.

The secondary coil 2b also has two lower electrical contact regions (or pads) 5a, 5b (hereinafter, respectively, first and second lower electrical contact regions 5a, 5b), configured to be electrically contacted in order to bias the secondary coil 2b with a secondary biasing voltage.

The first and the second lower electrical contact regions 5a, 5b both extend externally to the turns 5 of the secondary coil 2b.

In order to form a suitable electrical connection between an innermost turn (or internal turn) 5′ of the secondary coil 2b and the first lower electrical contact region 5a, a conductive track 13 extends into a metal level (also referred to as “cross-under” metal level) different from the metal level having the secondary coil 2b extending therein. In particular, the conductive track 13 extends at the bottom of the secondary coil 2b, considering the Z axis as the vertical axis. For example, the conductive track 13 is of the same material as the secondary coil 2b.

The outermost turn (or external turn) 5″ of the secondary coil 2b is electrically connected to the second lower electrical contact region 5b, for example through a first joining portion 38 which is continuous with the second lower electrical contact region 5b and with a first end of the secondary coil 2b (in detail, the external end of the turns 5) and which may be of the same material as the second lower electrical contact region 5b and the secondary coil 2b. In this case, in fact, it is not necessary to use a metal level different from that having the secondary coil 2b formed therein to form the connection track between the outermost turn and the second lower electrical contact region 5b.

It becomes apparent that, to avoid a short circuit between the conductive track 13 and all the turns of the secondary coil 2b, the conductive track 13 is electrically insulated from the secondary coil 2b (except for the innermost turn of the secondary coil 2b) by an interposed insulating layer 12, in particular of the same material as the galvanic insulation region 11.

Through the interposed insulating layer 12, there are formed a first conductive via 15 which connects vertically (i.e., along the Z axis) the innermost turn 5′ and the conductive track 13, and a second conductive via 18 which vertically connects the conductive track 13 and the first lower electrical contact region 5a. In particular, the conductive vias 15 and 18 are of the same material as the secondary coil 2b and the conductive track 13.

In detail, the innermost turn 5′ is connected through the first conductive via 15 to a first end 13′ of the conductive track 13, while the first lower electrical contact region 5a is connected through the second conductive via 18 to a second end 13″ of the conductive track 13, opposite to the first end 13′.

In greater detail, the innermost turn 5′ of the secondary coil 2b has a first structural portion 28 which defines a second end of the secondary coil 2b (in detail, the end placed internally to the turns 5, or internal end).

The first structural portion 28 comprises a first connection region 20 which is vertically superimposed (i.e., superimposed along the Z axis) on the first conductive via 15. In particular, the first connection region 20 and the first conductive via 15 are continuous with each other.

As better shown in FIG. 4, the first lower electrical contact region 5a is comprised in a lower electrical contact conductive region 32 of the secondary coil 2b, which is coplanar with the turns 5, is physically separated from the latter (i.e., it is not in direct physical contact with the latter) and is electrically connected to the latter through the conductive track 13 and the conductive vias 15 and 18.

The lower electrical contact conductive region 32 comprises, in addition to the first lower electrical contact region 5a, also a second structural portion 30 better described hereinbelow.

The first lower electrical contact region 5a and the second structural portion 30 are joined together, for example through a second joining portion 34 of the lower electrical contact conductive region 32. The second joining portion 34 extends between the first lower electrical contact region 5a and the second structural portion 30, in such a way as to be continuous with both. In detail, the first lower electrical contact region 5a, the second joining portion 34 and the second structural portion 30 are of the same conductive material (e.g., copper or gold).

The second structural portion 30 comprises a second connection region 22 which is vertically superimposed on the second conductive via 18. In particular, the second connection region 22 and the second conductive via 18 are continuous with each other.

The turns of each coil 2a, 2b are arranged in succession with electrical continuity between the two respective ends 4a, 4b and 5a, 5b to form the respective spirals. Any spiral shape is comprised in the present disclosure, including circular spirals, quadrangular spirals and polygonal spirals, in particular with rounded corners.

In radial direction (i.e., along an axis coplanar to the respective coil 2a, 2b considered and passing through a center of the respective coil 2a, 2b, shown in FIG. 4 with the reference 36), portions of the first or second insulating layer 8, 9 of electrically insulating or dielectric material (in detail, polymeric material such as PIX) extend between the turns of each respective coil 2a, 2b.

The magnetic core 3 (not illustrated in FIG. 2) may optionally be present at a central region of the coils 2a, 2b, i.e., a region internally delimited by the innermost turns of the coils 2a, 2b.

FIG. 3 is a plan view (on the XY plane) of the primary coil 2a of the transformer 2, according to an exemplary embodiment.

In FIG. 3, the primary coil 2a has turns 4 which exemplarily have a uniform and constant width in the radial direction. Nonetheless, the turns 4 may also have variable width. Furthermore, the turns 4 of the primary coil 2a may have a shape different from the circular one shown in FIG. 3 (e.g., quadrangular turns, etc.).

FIG. 4 is a plan view (on the XY plane) of the secondary coil 2b of the transformer 2, according to an exemplary embodiment.

In FIG. 4, the secondary coil 2b has the turns 5 which exemplarily have a uniform and constant width in the radial direction. Nonetheless, the turns 5 may also have variable width. Furthermore, the turns 5 of the secondary coil 2b may have a shape different from the circular one shown in FIG. 3 (e.g., quadrangular turns, etc.).

As shown in FIG. 4, the first structural portion 28 comprises, in addition to the first connection region 20, also a first stress dissipation region 24. Similarly, the second structural portion 30 comprises, in addition to the second connection region 22, also a second stress dissipation region 26.

The first stress dissipation region 24 is joined to the first connection region 20 in such a way as to be continuous with the latter (in detail, it is of the same material as the first connection region 20). The first connection region 20 is interposed between the first stress dissipation region 24 and the remaining part of the innermost turn 5′ (and in general of the secondary coil 2b).

Similarly, the second stress dissipation region 26 is joined to the second connection region 22 in such a way as to be continuous with the latter (in detail, it is of the same material as the second connection region 22). The second connection region 22 is interposed between the second stress dissipation region 26 and the second joining portion 34.

In the embodiment of FIG. 4, the stress dissipation regions 24 and 26 have a curved (in detail bended) shape in plan view, in such a way as to facilitate the dissipation of mechanical stresses. For illustrative purposes, the stress dissipation regions 24 and 26 have a wavy, comma or teardrop shape.

In particular, the stress dissipation regions 24 and 26 are arched in such a way as to move away with respect to the turns of the secondary coil 2b.

In detail, the stress dissipation regions 24 and 26 each have a first end 24′ and 26′ and a second end 24″ and 26″ which are opposite to each other. The second ends 24″ and 26″ are at the respective connection regions 20 and 22, while the first ends 24′ and 26′ extend on the opposite side of the stress dissipation regions 24 and 26 with respect to the connection regions 20 and 22.

The stress dissipation regions 24 and 26 are curved in such a way that the first ends 24′ and 26′ have respective minimum distances E_{1′} and E_{2′} from the turns 5 which are greater than respective minimum distances E_{1″} and E_{2″} of the second ends 24″ and 26″ from the turns 5. In detail, the minimum distances E_{1′}, E_{2′}, E_{1″}, E_{2″} are measured between the respective ends 24′, 26′, 24″, 26″ and the points of the turns 5 which are closer to the respective ends 24′, 26′, 24″, 26″. For example, the minimum distances E_{1′}, E_{2′}, E_{1″}, E_{2″} are measured radially with respect to the center 36 of the secondary coil 2b.

In other words, the first end 24′ is closer to the center 36 with respect to the second end 24″ given that the first structural portion 28 is radially internal to the turns 5, and the first end 26′ is more distant from the center 36 with respect to the second end 26″ given that the second structural portion 30 is radially external to the turns 5.

According to one embodiment, the stress dissipation regions 24 and 26 have a curved (in detail concave) surface with a curvature radius between about 10 μm and about 600 μm and for example equal to about 150 μm. The curvature radii of the stress dissipation regions 24 and 26 may also be different from each other.

The stress dissipation regions 24 and 26 may have relative distances between the respective first ends 24′, 26′ and the respective second ends 24″, 26″ which are comprised between about 150 μm and about 350 μm and for example are equal to about 250 μm. These relative distances may also be different from each other.

Furthermore, the first ends 24′ and 26′ are vertically misaligned with respect to the conductive track 13 and the primary coil 2a. In other words, the first ends 24′ and 26′ are staggered along the Z axis with respect to the conductive track 13 and the primary coil 2a, so as not to extend over or under other metal parts of the transformer 2 (i.e., other parts with high CTE).

It has been verified that the stress dissipation regions 24 and 26 reduce the mechanical stress that may generate between the respective connection regions 20 and 22 and the respective conductive vias 15 and 18 following temperature variations (e.g., due to thermal cycling performed for manufacturing the transformer 2 or to the use of the transformer 2). This reduction in mechanical stress avoids the formation of cracks and detachment between the connection regions 20 and 22 and the respective conductive vias 15 and 18, thus making the transformer 2 more stable and reliable in use.

In detail, the previously described shape of the stress dissipation regions 24 and 26 moves the accumulation point of the mechanical stresses away from the conductive vias 15 and 18 and causes the dissipation of these mechanical stresses in zones that are immersed in the previously described polymeric material (e.g., PIX) and which are distant from the turns 5.

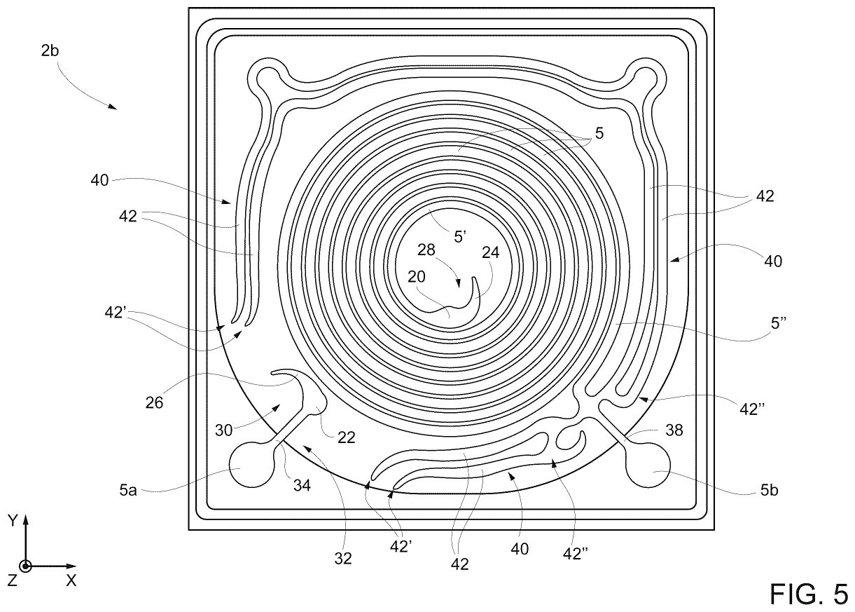

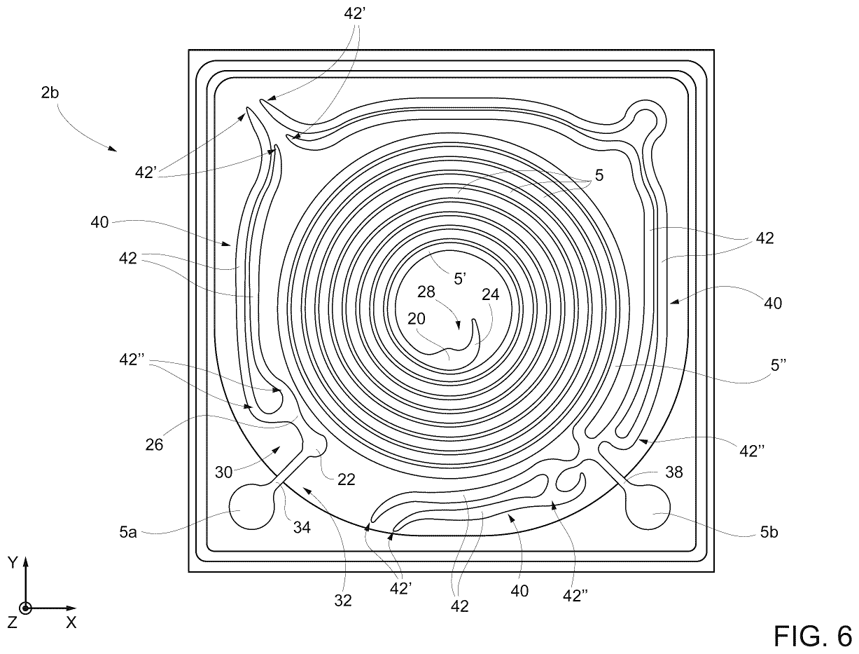

According to a different embodiment shown in FIGS. 5 and 6, the secondary coil 2b further includes one or more support elements 40 which are coplanar with the turns 5 and have a free shape with topography which, in the plane of the secondary coil 2b, surrounds at least partially the external perimeter of the turns 5. Hereinafter, the case of multiple support elements 40 is exemplarily considered.

In detail, the support elements 40 are coupled (in detail joined) to the first joining portion 38 and/or to the second joining portion 34. Additionally, or alternatively, the support elements 40 may be defined by the second structural portion 30, or may be coupled (in detail joined) to the latter.

The support elements 40 may be of the same material as the second structural portion 30, the first joining portion 38 and the second joining portion 34, and may have the same thickness as the second structural portion 30, the first joining portion 38 and the second joining portion 34. For example, they may be made using “electrochemical deposition (ECD) plating”, in particular, simultaneously with the second structural portion 30, the first joining portion 38 and the second joining portion 34.

The support elements 40 provide support for the parts of the transformer 2 that extend over the level of the support elements 40, in particular for the galvanic insulation region 11. Their arrangement radially external with respect to the turns 5 allows the galvanic insulation region 11 to be supported in a substantially homogeneous manner with respect to what is done by the same turns 5. In other words, the presence of the support elements 40 provides the galvanic insulation region 11 at the extremal regions of the transformer 2 (i.e., the regions which, in plan view, are external to the turns 5) the same support that the turns 5 provide at a central region of the transformer 2 (i.e., at a region which, in plan view, is central and corresponding, or internal, to the turns 5). This allows obtaining a uniform thickness of the insulating layers that form the galvanic insulation region 11, thus avoiding the formation of regions at a reduced distance between the coils 2a, 2b. This avoids the localized and unwanted increase in the electric field between the external turns 4″, 5″ of the coils 2a, 2b and therefore prevents the malfunction of the transformer 2.

For this purpose, the support elements 40 may surround a part of the external perimeter of the turns 5 which may be between about 50% and about 95% of the external perimeter, and for example be equal to about 75% of the external perimeter.

The support elements 40 include support fingers 42.

The support fingers 42 have an open shape, i.e., do not define a closed shape (e.g., have a shape different from the annular shape). In fact, the open shape of the support fingers 42 prevents currents from being generated along closed paths (e.g., circular paths) which could give rise to unwanted magnetic fields and energy losses (e.g., due to induced parasitic currents).

Furthermore, the support fingers 42 are electrically coupled to the first and/or the second lower electrical contact regions 5a, 5b, in such a way as to be at the same electrical voltage as the first and/or the second lower electrical contact regions 5a, 5b, respectively. In other words, the support fingers 42 are not of the floating type.

In detail, the support fingers 42 have an elongated shape (e.g., a strip shape, in plan view) and have a first end 42′ and a second end 42″, opposite to each other. The support fingers 42 are physically coupled through their second ends 42″ to the first joining portion 38 and/or to the second joining portion 34 (therefore to the first and/or the second lower electrical contact region 5a, 5b, respectively). The first ends 42′ are instead immersed in the electrically insulating or dielectric material (here PIX for illustrative purposes).

In general, the support fingers 42 have a free shape as long as it is open, therefore the shapes shown in FIGS. 4 and 5 are indicated purely for illustrative and non-limiting purposes, since other shapes may be similarly considered.

For example, the support elements 40 have a minimum distance, measured in the radial direction, from the outermost turn 5″ of the secondary coil 2b which may be greater than about 50 μm.

In the embodiment of FIG. 5, the support elements 40 are exemplarily included in the first joining portion 38.

In FIG. 5, the support elements 40 are coupled to the first joining portion 38, which extends radially between the outermost turn 5″ and the second lower electrical contact region 5b. The support elements 40 here have two branches which extend circumferentially around the turns 5 starting from the first joining portion 38, one clockwise and the other counterclockwise, for example up to being in proximity to the second structural portion 30 (but without being in contact with the latter).

For exemplary purposes, each branch includes two support fingers 42 which may extend approximately parallel to each other around the turns 5. In other words, the support fingers 42 of each branch are, in a radial direction with respect to the center 36, one internal and one external to each other. The support fingers 42 have a shape, dimension and mutual arrangement such as to maximize the covered area, in order to optimize the planarization of the galvanic insulation region 11.

As previously described, other shapes, dimensions, numbers and arrangements of the support fingers 42 may be similarly considered (e.g., three or more support fingers 42 for each branch, different numbers of support fingers 42 for different branches, etc.). Furthermore, the support elements 40 may be, alternatively or, in part, in combination with what has previously been described, coupled to the second joining portion 34.

In the embodiment of FIG. 6, the support elements 40 are exemplarily coupled in part in the first joining portion 38 and in part in the second structural portion 30.

In FIG. 6, the support elements 40 coupled to the first joining portion 38 are similar to what has been described in FIG. 5. Instead, the support elements 40 coupled to the second structural portion 30 are joined to the second connection region 22 and, in the example of FIG. 6, have a branch with two support elements 40 which extend circumferentially with respect to the turns 5 and clockwise with respect to the second connection region 22.

In detail, in this embodiment the support elements 40 coupled to the first joining portion 38 define the second stress dissipation region 26 previously described and in particular have an at least partially curved shape and have the first ends 42′ which have a distance from the turns 5 which is greater than the distance of the second ends 42″ from the turns 5. Furthermore, the first ends 42′ are vertically misaligned with respect to the conductive track 13 and the primary coil 2a. In this manner, the second stress dissipation region 26 is useful both to improve the distribution of any mechanical stresses and to ensure a uniform thickness of the galvanic insulation region 11.

From an examination of the characteristics of the disclosure made according to the present disclosure, the advantages that it affords are evident.

In particular, the stress dissipation regions 24, 26 improve the distribution of mechanical stresses caused by the CTE difference in the materials that form the transformer 2 following thermal cycling due to the manufacturing steps of the transformer 2 or its use. In fact, the stress dissipation regions 24, 26 balance the torque generated by the mechanical stress caused by the thermal deformation during the thermal cycling of the metal material used.

For example, the first stress dissipation region 24 reduces the stress at the first conductive via 15 by up to about 35% (a value clearly dependent on the manufacturing process used and materials chosen). This avoids the previously described phenomena of delamination and breakdown of the connection regions 20, 22 from the conductive vias 15, 18.

Furthermore, the support elements 40 improve the planarization of the galvanic insulation region 11, avoiding non-uniformity in the thickness of the galvanic insulation region 11. This occurs by providing a support similar to that generated by the secondary coil 2b.

The support elements 40 keep the electrical performances of the transformer 2 (e.g., the quality factor and the maximum gain obtainable) substantially unchanged, therefore they do not significantly affect its operation.

Accordingly, the stress dissipation regions 24, 26 and the support elements 40 avoid damage to the galvanic insulation region 11, such as its breakdown.

The stress dissipation regions 24, 26 and the support elements 40 may be formed together with the secondary coil 2b (e.g., through a same lithography mask, suitably patterned). Therefore, their presence does not complicate the manufacturing of the transformer 2, since it does not require additional steps in the manufacturing process.

Finally, it is clear that modifications and variations may be made to the disclosure described and illustrated herein without thereby departing from the scope of the present disclosure, as defined in the attached claims. For example, the different embodiments described may be combined with each other to provide further solutions.

Furthermore, the stress dissipation regions 24, 26 may be used not only in planar transformers for galvanic insulation, but also in any galvanic insulation device and in general electronic device where a conductive via is present and the CTE difference of the materials used is high.

Furthermore, the number of conductive vias may be different from what has previously been described (e.g., a single conductive via or more than two conductive vias), as well as their arrangement and function (e.g., they might be conductive vias coupled to the primary coil 2a instead of the secondary coil 2b).

Furthermore, it is possible to have even only one of the structural portions 28 and 30.

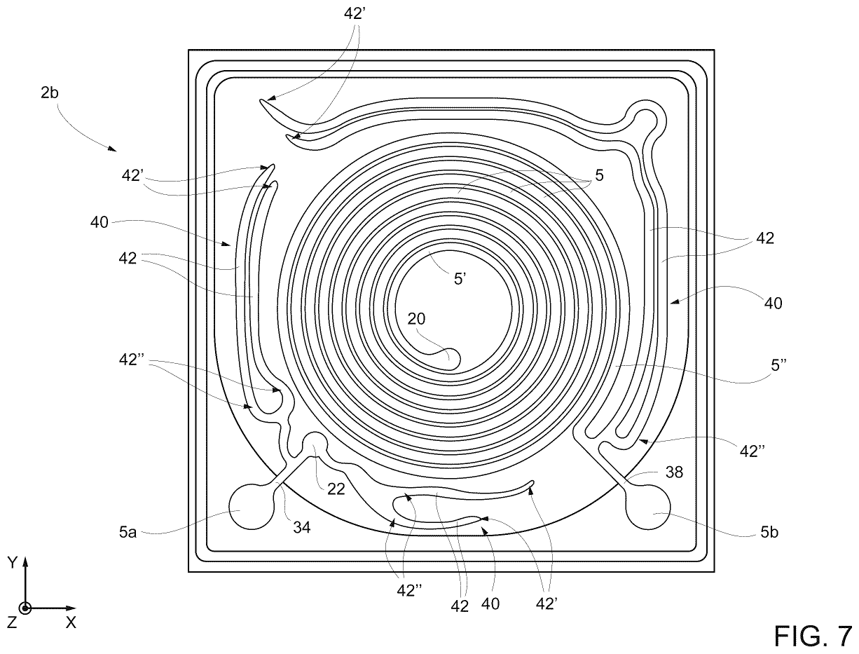

Furthermore, according to a different embodiment, the transformer 2 includes the support elements 40 while the stress dissipation regions 24 and 26 are absent instead. An example of this embodiment of the transformer 2 is shown in FIG. 7.

In this case wherein the transformer 2 has no stress dissipation regions 24 and 26, the connection with the conductive vias 15 and 18 occurs in a per se known manner. In other words, the connection regions 20, 22 are joined to the conductive vias 15, 18 and any mechanical stresses are dissipated at the connection regions 20, 22.

Similarly to what has previously been described, the support elements 40 are coupled to at least one of the second connection region 22, the first joining portion 38 and the second joining portion 34.

In the example of FIG. 7, the support elements 40 include a branch with two support fingers 42 which extends clockwise around the turns 5 starting from the second joining portion 34, a branch with two support fingers 42 which extends counterclockwise around the turns 5 starting from the second connection region 22, and a branch with two support fingers 42 which extends counterclockwise around the turns 5 starting from the first joining portion 38. Nonetheless, different structures of the support elements 40 (e.g., by shape and number of support fingers 42) may similarly be considered. For example, each branch may include three or more support fingers 42, compatibly with the free area available.

In FIG. 7, the shape and the arrangement of the support elements 40 are free as long as, similarly to what has previously been described, the support fingers 42 have an open shape and are electrically coupled to the first and/or the second lower electrical contact region 5a, 5b.

In the embodiment of FIG. 7 and differently from what has previously been described for example with reference to FIG. 6, the support elements 40 coupled to the second connection region 22 may not have an at least partially curved shape and may not have the first ends 42′ which have a distance from the turns 5 greater than the distance of the second ends 42″ from the turns 5 and which are vertically misaligned with respect to the conductive track 13 and the primary coil 2a. In fact, in this case these support elements 40 are present for the purpose of improving the planarization of the transformer 2 and not also in order to improve the dissipation of mechanical stresses previously described.

A galvanic insulation device (2) is summarized as including: an upper coil (2a) extending in a first insulating layer (8), parallel to a lying plane (XY); a lower coil (2b) extending in a second insulating layer (9), parallel to the lying plane (XY); a galvanic insulation region (11) extending between the first (8) and the second (9) insulating layers; and at least a first conductive via (15; 18), wherein each of the upper coil (2a) and the lower coil (2b) includes a plurality of turns (4; 5), a first electrical contact region (4a; 5a) and a second electrical contact region (4b; 5b), electrically coupled to the plurality of turns (4; 5), wherein the first conductive via (15; 18) is coupled to a first structural portion (28; 30) of the upper coil (2a) or of the lower coil (2b), and is coupled to the turns (4; 5) or to the first (4a; 5a) or second (4b; 5b) electrical contact region, wherein the first structural portion (28; 30) includes a first stress dissipation region (24; 26) having a curved shape parallel to the lying plane (XY) and having a first end (24′; 26′) misaligned, along a first axis (Z) orthogonal to the lying plane (XY), with respect to the other of the upper coil (2a) and the lower coil (2b).

The first structural portion (28; 30) further includes a first connection region (20; 22) which is coupled to the first conductive via (15; 18), is aligned along the first axis (Z) with the first conductive via (15; 18) and is interposed, parallel to the lying plane (XY), between the first stress dissipation region (24; 26) and the turns (4; 5) or the first (4a; 5a) or second (4b; 5b) electrical contact region having the first stress dissipation region (24; 26) coupled thereto, wherein the first stress dissipation region (24; 26) further has a second end (24″; 26″) opposite to the first end (24′; 26′), the first stress dissipation region (24; 26) is joined to the first connection region (20; 22) through the second end (24″; 26″).

The first end (24′; 26′) of the first stress dissipation region (24; 26) has a minimum distance (E_{1′}; E_{2′}) from the turns (5) of the respective upper coil (2a) or lower coil (2b) which is greater than a respective minimum distance (E_{1″}; E_{2″}) of the second end (24″; 26″) of the first stress dissipation region (24; 26) from the turns (5) of the respective upper coil (2a) or lower coil (2b).

The first conductive via (15; 18) is coupled to the first structural portion (28; 30) of the lower coil (2b).

The lower coil (2b) includes: an internal turn (5′); an external turn (5″); one or more intermediate turns (5), extending with electrical continuity between the internal turn (5′) and the external turn (5″), electrically coupled to the internal turn and the external turn, wherein the internal turn (5′), the external turn (5″) and the one or more intermediate turns (5) extend parallel to the lying plane (XY) according to a spiral path, wherein the first (5a) and the second (5b) electrical contact regions of the lower coil (2b) extend externally to the turns (5) of the lower coil (2b), wherein the external turn (5″) of the lower coil (2b) is electrically connected to the second electrical contact region (5b) of the lower coil (2b), wherein the galvanic insulation device (2) further includes a conductive track (13) which extends parallel to the lying plane (XY) and, along the first axis (Z), at a different level with respect to a level having the secondary coil (2b) extending therein, the conductive track (13) having a first end (13′) and a second end (13″) opposite to each other, wherein the galvanic insulation device (2) further includes a second conductive via (18; 15), and wherein one of the first conductive via (15; 18) and the second conductive via (18; 15) extends between an internal end of the internal turn (5′) of the lower coil (2b) and the first end (13′) of the conductive track (13) and the other of the first conductive via (15; 18) and the second conductive via (18; 15) electrically connects the second end (13″) of the conductive track (13) and the first electrical contact region (5a) of the lower coil (2b), which defines a conductive path between the internal turn (5′) of the lower coil (2b) and the first electrical contact region (5a) of the lower coil (2b) through the conductive track (13) and the first (15; 18) and second (18; 15) conductive vias.

The first structural portion (28) defines the internal end of the internal turn (5′) of the lower coil (2b) and the first conductive via (15) extends between the first structural portion (28) and the first end (13′) of the conductive track (13), wherein the first end (24′) of the first structural portion (28) is misaligned, along the first axis (Z), with respect to the upper coil (2a) and the conductive track (13), wherein the second conductive via (18) extends between the second end (13″) of the conductive track (13) and a second structural portion (30) of the lower coil (2b), which is coupled to the first electrical contact region (5a) of the secondary coil (2b), and wherein the second structural portion (30) includes a second stress dissipation region (26) having a curved shape parallel to the lying plane (XY) and having a first end (26″) misaligned, along the first axis (Z), with respect to the upper coil (2a) and the conductive track (13).

The first stress dissipation region (24; 26) has a concave surface having a curvature defined by a curvature radius between 10 μm and 600 μm.

The first insulating layer (8), the second insulating layer (9) and the galvanic insulation region (11) include polymeric material, in particular polyimide.

The galvanic insulation device (2) is a planar-type transformer and wherein the upper coil (2a) and the lower coil (2b) are aligned with each other along the first axis (Z).

The lower coil (2b) further includes one or more support elements (40) which are coplanar with the turns (5) of the lower coil (2b), are external to the turns (5) of the lower coil (2b) and at least partially surround an external perimeter of the turns (5) of the lower coil (2b).

The support elements (40) surround between 50% and 95% of the external perimeter of the turns (5) of the lower coil (2b).

The one or more support elements (40) include support fingers (42) which have an open shape and which are electrically coupled to the first (5a) and/or to the second (5b) electrical contact region of the lower coil (2b).

The lower coil (2b) further includes a first (38) and a second (34) joining portion which are coplanar with the turns (5) of the lower coil (2b), wherein the first joining portion (38) extends between the external turn (5″) of the lower coil (2b) and the second electrical contact region (5b) of the lower coil (2b), and the second joining portion (34) extends between the first electrical contact region (5a) of the lower coil (2b) and the other of the first conductive via (15; 18) and the second conductive via (18; 15), wherein the support fingers (42) have an elongated shape, have a first (42′) and second (42″) ends opposite to each other and are joined to the first (38) or second (34) joining portions through the second ends (42″).

The second structural portion (30) defines one of the support elements (40) and wherein the second stress dissipation region (26) forms one of the support fingers (42).

The support elements (40) have at least two branches of support fingers (42) extending circumferentially around the turns (5) of the secondary coil (2b) starting from the first (38) and/or second (34) joining portion, one clockwise and the other counterclockwise.

An electronic device (1) is summarized as including any of the above mentioned galvanic insulation device (2).

An electronic device is summarized as including a galvanic insulation device, which includes a first coil extending in a first insulating layer; a second coil extending in a second insulating layer; a galvanic insulation layer extending between the first and the second coils; and a first conductive via electrically coupled to the second coil; wherein each of the first coil and the second coil includes a turn, a first electrical contact region, and a second electrical contact region, the first electrical contact region and the second electrical contact region electrically coupled to two opposite ends of the turn; wherein the second coil further includes a stress dissipation region arched away from the turn of the second coil in the second insulating layer, and the stress dissipation region misaligned with respect to the first coil.

The galvanic insulation device further includes: a second conductive via electrically coupled to the second coil; and a conductive track at a different level with respect to a level having the second coil extending therein, the conductive track having a first end and a second end opposite to each other, one end of the turn of the second coil electrically coupled to the first end of the conductive track by the first conductive via, and the other end of the turn of the second coil electrically coupled to the first electrical contact region by the second conductive via.

A galvanic insulation device is summarized as including: an upper coil extending in an upper insulating layer, the upper coil including a first upper electrical contact region, a second upper electrical contact region, and a upper turn electrically coupling the first upper electrical contact region and the second upper electrical contact region; a lower coil extending in a lower insulating layer, the lower coil including a first lower electrical contact region, a second lower electrical contact region, a lower turn electrically coupling the first lower electrical contact region and the second lower electrical contact region, and a stress dissipation region electrically coupled to an end of the lower turn or the first lower electrical contact region, the stress dissipation region arched away from the lower turn and misaligned with the upper coil; and a galvanic insulation layer extending between the upper and the lower insulating layers.

The stress dissipation region has a first end and a second end opposite to each other, the first end arched away from the lower turn, the second end electrically coupled to an end of the lower turn or the first lower electrical contact region, a minimum distance between the first end and the lower turn is greater than a minimum distance between the second end and the lower turn.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A galvanic insulation device, comprising:
an upper coil extending in a first insulating layer, parallel to a lying plane;
a lower coil extending in a second insulating layer, parallel to the lying plane;
a galvanic insulation region extending between the first and the second insulating layers; and
at least a first conductive via,
wherein each of the upper coil and the lower coil comprises a plurality of turns, a first electrical contact region, and a second electrical contact region, the first electrical contact region and the second electrical contact region electrically coupled to the plurality of turns,
wherein the first conductive via is coupled to a first structural portion of the upper coil or of the lower coil, and is coupled to the turns or to the first or second electrical contact region, and
wherein the first structural portion comprises a first stress dissipation region having a curved shape parallel to the lying plane and having a first end misaligned, along a first axis orthogonal to the lying plane, with respect to the other of the upper coil and the lower coil.

2. The galvanic insulation device according to claim 1, wherein the first structural portion further comprises a first connection region which is coupled to the first conductive via, is aligned along the first axis with the first conductive via and is interposed, parallel to the lying plane, between the first stress dissipation region and the turns or the first or second electrical contact region having the first stress dissipation region coupled thereto,
wherein the first stress dissipation region further has a second end opposite to the first end, the first stress dissipation region is joined to the first connection region through the second end.

3. The galvanic insulation device according to claim 2, wherein the first end of the first stress dissipation region has a minimum distance from the turns of the respective upper coil or lower coil which is greater than a respective minimum distance of the second end of the first stress dissipation region from the turns of the respective upper coil or lower coil.

4. The galvanic insulation device according to claim 1, wherein the first conductive via is coupled to the first structural portion of the lower coil.

5. The galvanic insulation device according to claim 4, wherein the lower coil comprises: an internal turn; an external turn; one or more intermediate turns, extending with electrical continuity between the internal turn and the external turn, electrically coupled to the internal turn and the external turn, wherein the internal turn, the external turn and the one or more intermediate turns extend parallel to the lying plane according to a spiral path,
wherein the first and the second electrical contact regions of the lower coil extend externally to the turns of the lower coil,
wherein the external turn of the lower coil is electrically connected to the second electrical contact region of the lower coil,
wherein the galvanic insulation device further comprises a conductive track which extends parallel to the lying plane and, along the first axis, at a different level with respect to a level having the lower coil extending therein, the conductive track having a first end and a second end opposite to each other,
wherein the galvanic insulation device further comprises a second conductive via, and
wherein one of the first conductive via and the second conductive via extends between an internal end of the internal turn of the lower coil and the first end of the conductive track and the other of the first conductive via and the second conductive via electrically connects the second end of the conductive track and the first electrical contact region of the lower coil, which defines a conductive path between the internal turn of the lower coil and the first electrical contact region of the lower coil through the conductive track and the first and second conductive vias.

6. The galvanic insulation device according to claim 5, wherein the first structural portion defines the internal end of the internal turn of the lower coil, and the first conductive via extends between the first structural portion and the first end of the conductive track,
wherein the first end of the first structural portion is misaligned, along the first axis, with respect to the upper coil and the conductive track,
wherein the second conductive via extends between the second end of the conductive track and a second structural portion of the lower coil, which is coupled to the first electrical contact region of the secondary coil, and
wherein the second structural portion comprises a second stress dissipation region having a curved shape parallel to the lying plane and having a first end misaligned, along the first axis, with respect to the upper coil and the conductive track.

7. The galvanic insulation device according to claim 1, wherein the first stress dissipation region has a concave surface having a curvature defined by a curvature radius between 10 μm and 600 μm.

8. The galvanic insulation device according to claim 1, wherein the first insulating layer, the second insulating layer and the galvanic insulation region comprise polymeric material.

9. The galvanic insulation device according to claim 8, wherein the first insulating layer, the second insulating layer and the galvanic insulation region comprise polyimide.

10. The galvanic insulation device according to claim 1, wherein the galvanic insulation device is a planar-type transformer, and wherein the upper coil and the lower coil are aligned with each other along the first axis.

11. The galvanic insulation device according to claim 1, wherein the lower coil further comprises one or more support elements which are coplanar with the turns of the lower coil, are external to the turns of the lower coil, and at least partially surround an external perimeter of the turns of the lower coil.

12. The galvanic insulation device according to claim 11, wherein the support elements surround between 50% and 95% of the external perimeter of the turns of the lower coil.

13. The galvanic insulation device according to claim 11, wherein the one or more support elements comprise support fingers which have an open shape and which are electrically coupled to the first or to the second electrical contact region of the lower coil.

14. The galvanic insulation device according to claim 5, wherein the lower coil further comprises a first and a second joining portion which are coplanar with the turns of the lower coil,
wherein the first joining portion extends between the external turn of the lower coil and the second electrical contact region of the lower coil, and the second joining portion extends between the first electrical contact region of the lower coil and the other of the first conductive via and the second conductive via, and
wherein the support fingers have an elongated shape, have a first and second ends opposite to each other, and are joined to the first or second joining portions through the second ends.

15. The galvanic insulation device according to claim 6, wherein the second structural portion defines one of the support elements, and wherein the second stress dissipation region forms one of the support fingers.

16. The galvanic insulation device according to claim 11, wherein the support elements have at least two branches of support fingers extending circumferentially around the turns of the secondary coil starting from the first or second joining portion, one clockwise and the other counterclockwise.

17. An electronic device comprising:
a galvanic insulation device, including:
a first coil extending in a first insulating layer along a first direction;
a second coil extending in a second insulating layer;
a galvanic insulation layer extending between the first and the second coils; and
a first conductive via electrically coupled to the second coil;
wherein each of the first coil and the second coil comprises a turn, a first electrical contact region, and a second electrical contact region, the first electrical contact region and the second electrical contact region electrically coupled to two opposite ends of the respective first or second coil;
wherein the second coil further comprises a stress dissipation region arched away from the second coil in the second insulating layer, and the stress dissipation region does not overlap to the first coil along a second direction that is transverse to the first direction.

18. The electronic device according to claim 17, wherein the galvanic insulation device further includes:
a second conductive via electrically coupled to the second coil; and
a conductive track at a different level with respect to a level having the second coil extending therein, the conductive track having a first end and a second end opposite to each other, one end of the turn of the second coil electrically coupled to the first end of the conductive track by the first conductive via, and the other end of the turn of the second coil electrically coupled to the first electrical contact region by the second conductive via.

19. A galvanic insulation device, comprising:
an upper coil extending in an upper insulating layer, the upper coil including a first upper electrical contact region, a second upper electrical contact region, and the upper coil electrically coupling the first upper electrical contact region and the second upper electrical contact region;
a lower coil extending in a lower insulating layer, the lower coil including a first lower electrical contact region, a second lower electrical contact region, the lower coil electrically coupling the first lower electrical contact region and the second lower electrical contact region, and a stress dissipation region electrically coupled to an end of the first lower electrical contact region, the stress dissipation region arched away from the lower coil and not overlapping with the upper coil; and
a galvanic insulation layer extending between the upper and the lower insulating layers.

20. The galvanic insulation device according to claim 19, wherein the stress dissipation region has a first end and a second end opposite to each other, the first end arched away from the lower coil, the second end electrically coupled to an end of the lower coil or the first lower electrical contact region, a minimum distance between the first end and the lower coil is greater than a minimum distance between the second end and the lower coil.
